(19) United States
(12) Patent Application Publication
(10) Pub. No.: US 2014/0000396 A1
(43) Pub. Date: Jan. 2, 2014

(54) TRANSMISSION SOLENOID ASSEMBLY HAVING A MONOLITHIC BUSHING

(71) Applicant: Custom Tranz Inc. dba Valve Body Pro, San Jose, CA (US)

(72) Inventor: Bob Singh Sanghera, San Jose, CA (US)

(21) Appl. No.: 13/922,192

(22) Filed: Jun. 19, 2013

Related U.S. Application Data
(60) Provisional application No. 61/665,841, filed on Jun. 28, 2012.

(51) Int. Cl. H01F 3/00; F16H 61/00

(52) U.S. Cl. CPC H01F 3/00; F16H 61/0006
USPC 74/335; 335/255; 335/251

(57) ABSTRACT

A solenoid assembly for an automatic transmission according to one embodiment includes a monolithic bushing coupled to a coil assembly; a plunger received in an inner channel of the bushing; and a variable force valve being selectively actuated by the plunger.

### RELATED APPLICATIONS

This application claims priority to U.S. provisional patent application No. 61/665,841, filed Jun. 28, 2012, which is herein incorporated by reference.

### FIELD OF THE INVENTION

The present invention relates to motor transmissions, and more particularly, this invention relates to transmission solenoid assemblies having a monolithic bushing.

### BACKGROUND

Automatic transmissions for use in automobiles and other vehicles operate by incorporating electronic commands from a controlling computing device. In particular, such automatic transmissions include one or more solenoid assemblies which receive commands from the computing device to ensure efficient and reliable operation of the automatic transmission.

Upon receiving a signal from the a controlling computing device, the solenoid assembly opens and closes to a fluid (e.g., transmission fluid) pressure such that the fluid may periodically pass through the solenoid assembly, thereby controlling the upshift and downshift quality of the gears of the automatic transmission.

However, conventional solenoid assemblies constructed with traditional nested bushings, which have an outer sleeve surrounding an inner tube, incur a significant problem. Particularly, with time, conventional nested bushings begin to hinder motion of components in the coil assembly by causing increased friction therein. As a result, the increased friction may cause the shifting of the gears in the transmission to be delayed, violent (i.e., damaging), inefficient, etc. This is highly undesirable as it may result in poor gas mileage for the automotive, damage to the gears of the automatic transmission, etc.

### SUMMARY

A solenoid assembly for an automatic transmission according to one embodiment includes a monolithic bushing coupled to a coil assembly; a plunger received in an inner channel of the bushing; and a variable force valve being selectively actuated by the plunger.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1A is a side view of a solenoid assembly according to one embodiment.

FIG. 1B is an exploded view of the solenoid assembly shown in FIG. 1A.

FIG. 1C is an end view of the coil assembly shown in FIG. 1B taken along line 1C-1C.

FIG. 1D is an end view of the coil assembly shown in FIG. 1B taken along line 1D-1D.

FIG. 2A is a side view of a bushing according to one embodiment.

FIG. 2B is an end view of the bushing shown in FIG. 2A taken along line 2B-2B.

FIG. 2C is an end view of the bushing shown in FIG. 2A taken along line 2C-2C.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of a variable force solenoid assembly, systems incorporating the solenoid assembly such as automatic automotive transmissions and other devices, as well as operation and/or component parts thereof. Automatic automotive transmissions typically include three solenoid assemblies, but may have more or less depending on the desired embodiment.

In one general embodiment, a solenoid assembly for an automatic transmission includes a monolithic bushing coupled to a coil assembly; a plunger received in an inner channel of the bushing; and a variable force valve being selectively actuated by the plunger.

According to one embodiment, an automatic transmission system for use in automobiles and other vehicles operates by incorporating electronic commands from a controlling computing device. In particular, such automatic transmission includes one or more solenoid assemblies which receive commands from the computing device to ensure efficient and reliable operation of the automatic transmission.

Solenoid assemblies in various approaches may include a variable force valve, as well as a plunger and a spring which move in relative motion to a coil assembly and a top portion (described in further detail below). Moreover, a novel bushing is coupled to the coil assembly. A portion of the plunger passes through the bushing such that the relative motion between the plunger and the coil assembly is constrained along a common axis.

The relative motion between the plunger and the coil assembly of the solenoid assembly is caused by the variable force valve which is stimulated upon receiving a signal from the controlling computing device. The variable force valve opens and closes the solenoid assembly to a fluid (e.g., transmission fluid) pressure such that the fluid may periodically pass through the solenoid assembly, thereby controlling the upshift and downshift quality of the gears of the automatic transmission.

The embodiments described herein overcome a significant problem with conventional solenoid assemblies constructed with traditional nested bushings, which have an outer sleeve surrounding an inner tube. Particularly, with time, conventional nested bushings begin to hinder the relative motion between the plunger and the coil assembly by causing an increase in the friction therebetween. The friction may be a combination of static friction (e.g., stiction) and kinetic friction. The resulting reduced mobility also affects the abutting variable force valve and thus the transfer of transmission fluid as well. As a result, the increased friction may cause the shifting of the gears in the transmission to be delayed, violent (i.e., damaging), inefficient, etc. This is highly undesirable as it may result in poor gas mileage for the automotive, damage to the gears of the automatic transmission, etc.

Embodiments presented herein overcome the aforementioned drawbacks by reducing and/or eliminating the undesired results of using a conventional nested bushing in a solenoid assembly.

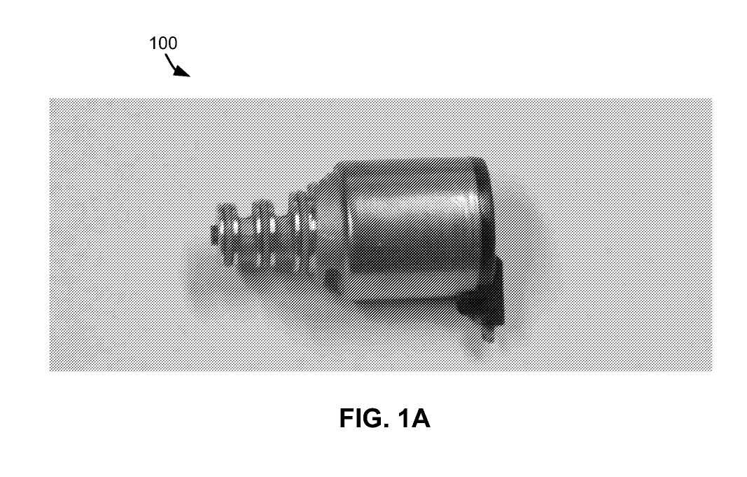

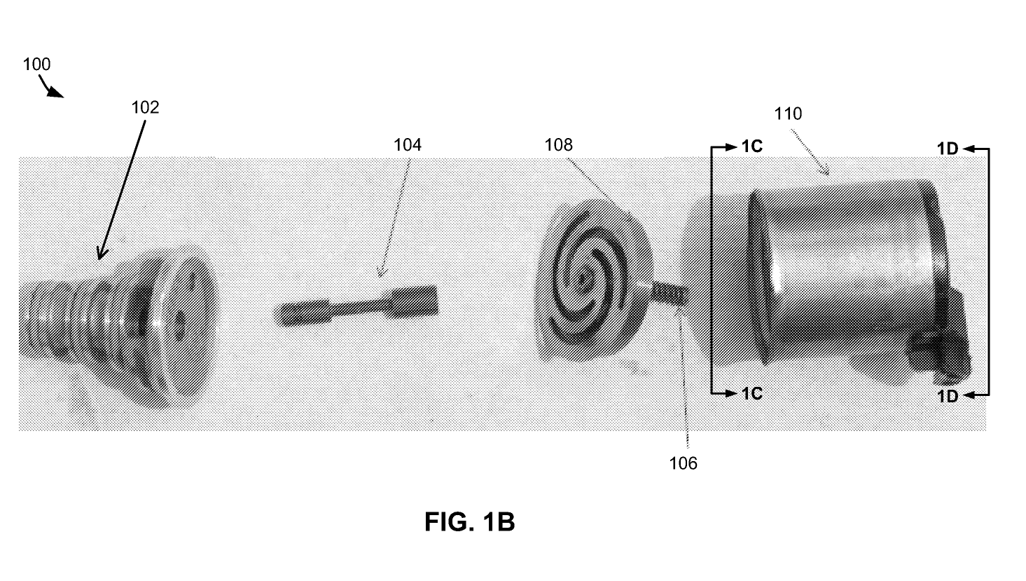

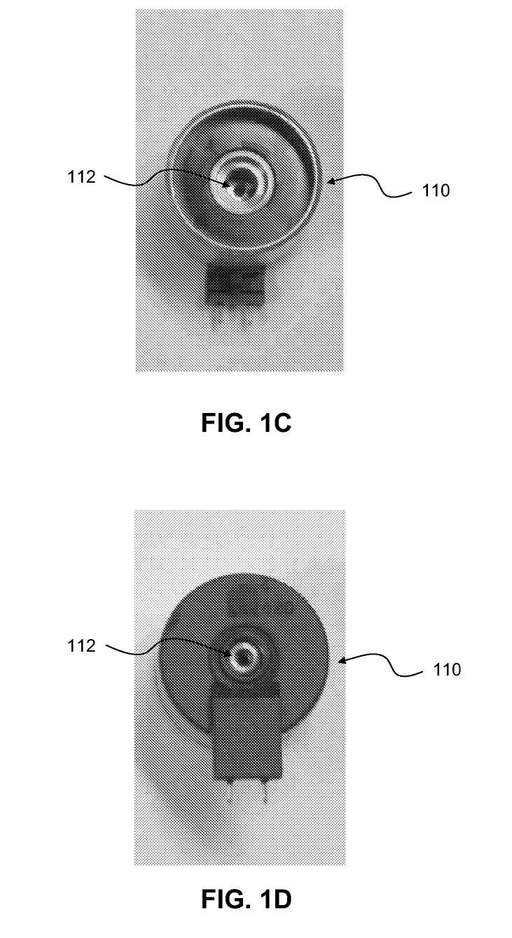

FIG. 1A depicts a solenoid assembly 100 for an automatic automotive transmission system in accordance with one embodiment. FIG. 1B is an exploded view of the solenoid assembly 110. As an option, the present solenoid assembly 100 may be implemented in conjunction with features from any other embodiment listed herein, such as those described with reference to the other FIGS. Of course, however, such solenoid assembly 100 and others presented herein may be used in various applications and/or in permutations which may or may not be specifically described in the illustrative embodiments listed herein. Further, the solenoid assembly 100 presented herein may be used in any desired environment.

Referring now to FIGS. 1A-1D, the solenoid assembly 100 includes a top portion 102, a variable force valve 104, a plunger 108, spring 106, a coil assembly 110, and a bushing 112. When the coil assembly 110 receives a signal from a computing device, the variable force valve 104 is caused to move relative to the top portion 102, thereby controlling the flow of fluids (e.g., transmission fluid) through the solenoid assembly 100. By regulating the flow of fluid, the solenoid assembly is able to control the quality of the shifting of the gears of the automatic transmission system (explained in further detail below).

The spring 106 biases the plunger 108 away from the coil assembly 110 and towards the top portion 102, preferably such that the plunger 108 abuts the variable force valve 104. According to a preferred approach, the plunger 108 may include a substance which is at least partially magnetic in nature, thereby making the plunger 108 at least partially magnetic. A magnetic field generated by the coil assembly 110 acts on the magnetic portion of the plunger 108 to induce motion thereof, which is translated to the variable force valve 104.

As noted above, the solenoid assembly 100 includes a bushing 112 which is coupled to the coil assembly 110. See FIGS. 1C-1D. The bushing 112 is preferably positioned such that, as described above, the relative motion between the plunger 108 and the coil assembly 110 is constrained along a common axis when the plunger 108 extends into the center of the bushing 112.

According to an illustrative embodiment, the solenoid assembly is preferably controlled by a computing device which relays commands to the coil assembly via an electronic connection. According to various approaches, the computing device may be electronically connected to the coil assembly via a wire, a cable, wirelessly, etc.

Upon receiving an electronic command from the computing device, the coil assembly actuates the plunger and consequently the variable force valve, thereby inducing a relative motion between the variable force valve and the top portion along their concentric axes. Such motion is preferably induced in a selective manner between an open and closed position. For example, the spring may bias the plunger and variable force valve towards an open or a closed position, depending on the design. In doing so, the variable force valve controls the flow of transmission fluid through the solenoid assembly, thereby causing shifting of the gears in the automatic transmission system as described above.

According to various approaches, the solenoid runs at frequencies from about 300 MHz (megahertz) to about 3500 MHz, depending on the signal received from the computing device, but could be higher or lower based on the desired embodiment. According to another approach, the solenoid may incorporate a duty control for the operational frequencies, which may be varied depending on the desired embodiment. Furthermore, the motion of the variable force valve and plunger may be from about 1.5 mm to about 2 mm, but may be higher or lower depending on the desired embodiment.

As described above, the plunger is preferably positioned such that at least a portion of the plunger passes through the bushing, thereby constraining the relative motion between the plunger and the coil assembly along a concentric axis.

As explained above, implementing conventional nested bushings in solenoid assemblies results in an undesired increase in friction between the bushing and the plunger traveling therethrough. Such friction causes the shifting of the gears in the automatic transmission to be delayed, violent (i.e., damaging), inefficient, etc. This is highly undesirable as it may result in poor gas mileage for the automotive, damage to the gears of the automatic transmission, etc. Moreover, due to the low levels of force used to actuate the solenoid assembly, even a slight increase in friction between the plunger and the bushing may compound these undesirable results.

Upon examination of several such conventional solenoid assemblies, it was found that contaminants are prone to quickly accumulate within the nested bushing, thereby causing the increased friction after minimal use.

Because there are no known or predictable solutions to the problem, various experiments were conducted in an attempt to eliminate such friction. Particularly, different bushing designs and constructions were incorporated in the solenoid assembly, and tested.

As a result, it was surprisingly found that a monolithic bushing, i.e., made from or as a single, solid piece of metal, essentially eliminated the friction between the bushing and the plunger, even after prolonged use. Moreover, it was found that the monolithic bushing is resistant to acquiring contaminants and thus does not induce a level of friction seen with the conventional nested bushings.

Thus, according to preferred embodiments, the monolithic bushing 112 is formed from or as a single, solid piece of metal. In illustrative approaches, the monolithic bushing 112 may include magnetic or nonmagnetic metal (e.g., a steel and other iron-based alloys, aluminum, titanium, etc. and alloys thereof). Nonmagnetic and magnetic metals were specifically found to provide the aforementioned surprising results in the particular environment in which used (an automatic transmission system), with nonmagnetic metals providing excellent performance, and magnetic metals providing even better performance. Based on these findings, it is believed that other materials such as other metals and possibly ceramics may provide similar results in the particular environment in which used, when the bushing is created as a monolith. Such other materials would be apparent to one skilled in the art after reading the present description of the surprising and unexpected results, and performing minimal experimentation based thereon.

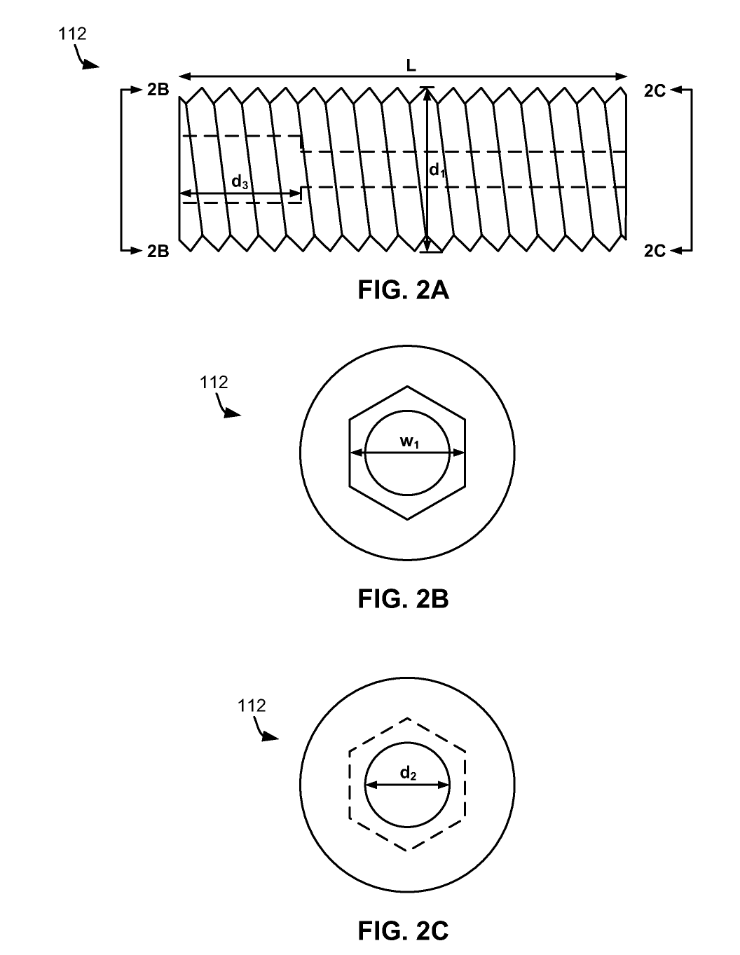

In a preferred approach, the bushing 112 may incorporate a threaded outer surface as shown in FIGS. 2A-2C. The bushing's 112 threaded outer surface may correspond to a matching threaded inner portion of the coil assembly 110 for mating with the bushing 112. Therefore, removal and/or replacement of an existing bushing may be easily conducted by simply unscrewing the existing bushing and then screwing in a replacement without having to disassemble any part of the solenoid assembly. However, in various other approaches, the bushing may include a smooth outer surface, a textured outer surface, a patterned outer surface, a tongue and/or groove coupling, etc. and may be coupled to the coil assembly by incorporating a binding agent (e.g., an adhesive), friction, fasteners (e.g., screws), etc.

Referring again to FIGS. 2A-2C, according to an illustrative embodiment which is in no way meant to limit the scope of the invention, and noting that dashed lines indicate presence of an inner surface of bushing 112 not visible from the angle of the particular view, the bushing 112 may be made from magnetic or nonmagnetic metals. Moreover, the bushing may have an overall length L from about 0.35 in to about 0.5 in, an inner channel having a diameter d₂ of about 0.081±0.0002 in. The bushing 112 may also have a cylindrical outer surface, as depicted, which may have an outer diameter d₁ from about 0.2 in to about 0.3 in, but may be higher or lower depending on the desired embodiment. Furthermore, at least a portion of one end of the bushing may include a hexagonal void having, the inner channel extending therefrom. As illustrated, the hexagonal void includes a broach, having a width w₁ that may be from about 1/16 in to about ½ in, more preferably about 7/64 in, but could be higher or lower. The hexagonal void may also extend to a depth d₃ which may be from about 0.1 in to about 0.2 in, but could be higher or lower.

As noted above, several solenoid assemblies may be present, e.g., in an automatic transmission system. According to one embodiment, a receiving assembly may include a solenoid assembly (e.g., see 100 of FIGS. 1A-1B) inserted therein, in addition to having ports for two or more additional solenoid assemblies. In a preferred approach, the solenoid assemblies may be operatively coupled to an automatic transmission, such that transmission fluid may flow directly into the solenoid assemblies via channels, vias, etc. However, in other approaches, the solenoid assemblies may be at a distance from an automatic transmission and the transmission fluid may be channeled thereto via piping, tubing, etc. Thus it may be beneficial for a transmission system to include a controller.

According to one embodiment, an automatic transmission system may include a transmission controller. In a preferred approach, the transmission controller may be configured to control shifting of gears in the transmission. Moreover, the solenoid assembly may also be coupled to the transmission controller. According to one approach, the transmission controller may include a duty cycle controller which may control an operational frequency of the solenoid assembly. However, according to other approaches, the transmission controller may include a transmission control unit, an engine control unit, powertrain control modules, etc.

In various embodiments, any of the approaches described above may be incorporated in the automatic transmission assembly of a motor vehicle of a type known in the art. Thus in different approaches, the solenoid assembly according to any of the embodiments described and/or suggested herein may be used in an automobile, e.g., a car, truck, tractor, golf cart, etc.; a nautical vessel having a motor, e.g., a boat, submarine, etc.; motorized machines, e.g., lawn mowers, wood chippers, snow blowers, etc.; etc.

Furthermore, according to various embodiments, methods for forming a preferred monolithic bushing with a threaded outer surface may include threading a solid piece of material via a lathe, tap and die set, casting, etc. Moreover, the void through the bushing's vertical axis may be formed by drill pressing, laser cutting, water jet cutting, etc. However, methods for forming the bushing may include any process which would be apparent to one skilled in the art upon reading the present description.

While various embodiments have been described above, it should be understood that they have been presented by way of example only, and not limitation. Thus, the breadth and scope of an embodiment of the present invention should not be limited by any of the above-described exemplary embodiments.

What is claimed is:

1. A solenoid assembly for an automatic transmission, the solenoid assembly comprising: a monolithic bushing coupled to a coil assembly; a plunger received in an inner channel of the bushing; and a variable force valve being selectively actuated by the plunger.

2. An automatic transmission system having the solenoid assembly of claim 1.

3. A vehicle having the automatic transmission system of claim 2.

4. The solenoid assembly of claim 1, wherein the solenoid assembly operates at frequencies between 300 MHz and 3500 MHz.

5. The solenoid assembly of claim 1, wherein the monolithic bushing is made from a single piece of a material.

6. The solenoid assembly of claim 5, wherein the material is a ceramic.

7. The solenoid assembly of claim 5, wherein the material is a metal.

8. The solenoid assembly of claim 7, wherein the metal is magnetic.

9. The solenoid assembly of claim 7, wherein the metal is nonmagnetic.

10. The solenoid assembly of claim 1, wherein the bushing has a cylindrical outer surface, wherein the outer surface has a diameter of about 0.236 inch.

11. The solenoid assembly of claim 1, wherein the bushing has a smooth outer surface.

12. The solenoid assembly of claim 1, wherein the bushing has a threaded outer surface.

13. The solenoid assembly of claim 12, wherein the coil assembly has a threaded inner surface, wherein the threaded outer surface of the bushing mates with the threaded inner surface of the coil assembly, wherein the bushing and the coil assembly are coupled concentrically.

14. The solenoid assembly of claim 1, wherein the bushing has a longitudinal length of about 0.403 inch.

15. The solenoid assembly of claim 1, wherein the bushing has a hexagonal void at a first end of the bushing, the inner channel extending from the hexagonal void toward a second end of the bushing, wherein the hexagonal portion is centered along a longitudinal axis of the bushing.

16. The solenoid assembly of claim 15, wherein the hexagonal void extends along the longitudinal axis of the bushing to a depth of about 0.125 inch from the first end of the bushing.

17. The solenoid assembly of claim 1, wherein the inner channel has a diameter of about 0.081 inch.

18. The automatic transmission system of claim 2, further comprising a transmission controller configured to control shifting of gears in the transmission, wherein the solenoid assembly is coupled to the transmission controller.

19. The automatic transmission system of claim 2, further comprising a duty cycle controller configured to control an operational frequency of the solenoid assembly.
